(19) United States
(12) Patent Application Publication
(10) Pub. No.: US 2017/0050226 A1
(43) Pub. Date: Feb. 23, 2017

(54) SELF-CLEANING MONITORING SYSTEM FOR BIOMASS PROCESSING

(71) Applicant: Parker-Hannifin Corporation, Cleveland, OH (US)

(72) Inventors: Peter Schupska, Columbus, OH (US); Phillip Allen Landis, Hilliard, OH (US)

(21) Appl. No.: 15/222,359

(22) Filed: Jul. 28, 2016

Related U.S. Application Data
(60) Provisional application No. 62/208,034, filed on Aug. 21, 2015.

(51) Int. Cl. B08B 9/093; B08B 9/46

(52) U.S. Cl. CPC B08B 9/093; B08B 9/46

(57) ABSTRACT

A self-contained monitoring assembly and method of self-cleaning for monitoring a process fluid. The assembly and method includes a closed loop of fluid flow having at least one housing having a sensor chamber, a sensor positioned within the sensor chamber, an injection nozzle receiving the process fluid through an inlet fluid passage and discharging the process fluid through an outlet passage into the sensor chamber, and a drain passage. The injection nozzle is positioned at an oblique angle relative to a contact surface of the sensor such that the contact surface is impinged by the process fluid. Impingement by the process fluid against the contact surface allows measurement of the process fluid by the sensor and cleans the contact surface.

### FIELD OF INVENTION

The present invention relates to a system and method for measuring characteristics of a fluid with levels of contamination or fouling agents, and more particularly to a method and system for cleaning and maintaining the cleanliness of in-process sensors.

### BACKGROUND OF THE INVENTION

Reducing the reliance on imported fossil fuels is significant for the future and various attempts have been made to develop a renewable placement from non-petroleum sources. Possible supplements for fossil fuels are biofuels such as ethanol, biodiesel, green diesel, and biogas, all of which are produced by biological cultivation systems. Examples of biological cultivation systems include the production of ethanol from corn, the production of biodiesel from vegetable oils, the production of biogas from animal manure, and the production of green diesel from algae. Using algal culture systems is advantageous as a fuel supply due to the fast growth rate and simple nutritional requirements of algae. Algal culture systems may also be used to supply food or diet supplements, generally replacing oils. Algae cultivation may use conventionally non-arable land and varieties of algae may be adapted to fresh or salt water. Algae cultivation, or algaculture, systems are generally one of three types: open ponds, semi-open photo-bio-reactors or closed photo-bio-reactors. Algaculture may be done at a low cost, but requires copious amounts of water and growers must monitor water quality and biological parameters to ensure optimal growth conditions. Thus, algae cultivation requires robust monitoring equipment that withstands environmental loads specifically related to algae. In-process sensors are generally used to interact with a process fluid to measure parameters related to water quality and growth.

The use of in-process sensors, however, has drawbacks. Bio-fouling of sensors is a problem in algaculture and traditional water quality. Normal operation of such sensors typically requires the surface of the sensor be free of contaminants, such as organic growth, solids, films or coatings, as well as sediment and other debris, in order to take accurate measurements. These conditions are referred to as ‘fouling’ of a sensor when inaccurate measurements are made. Some methods for cleaning in-process sensors require removing the sensor from service, which is time consuming and causes damage to the equipment. Other methods include using a cleaning agent, such as clean water, acids, detergents or air bubbles, which introduce undesirable material foreign to the process stream, risking damage to the algae cells.

### SUMMARY OF THE INVENTION

The present invention provides a monitoring system that maintains clean instruments without introducing cleaning agents or additional fluid volume to the system. The present invention eliminates a need for multiple branches for fluid movement in order to measure a fluid sample and clean the sensor.

A self-contained system for monitoring a process fluid may include at least one housing defining a sensor chamber configured to receive a flow of the process fluid, a sensor positioned within the sensor chamber and having a contact surface configured to measure a fluid characteristic of the process fluid, an injection nozzle having an inlet fluid passage receiving a predetermined amount of process fluid and an outlet fluid passage discharging the predetermined amount of process fluid into the sensor chamber, and a drain passage for removing the predetermined amount of process fluid from the sensor chamber. The injection nozzle is positioned at an oblique angle relative to the contact surface such that the contact surface is impinged by the process fluid, wherein impingement by the process fluid against the contact surface of the sensor allows measurement of the process fluid by the sensor and cleans the contact surface.

A method of self-cleaning a sensor in a monitoring assembly for a process fluid may include receiving a predetermined amount of process fluid into an inlet fluid passage of an injection nozzle, injecting the predetermined amount of process fluid from an outlet fluid passage of the injection nozzle into a sensor chamber housing the sensor, and removing the predetermined amount of process fluid from the sensor chamber via a drain passage. The sensor includes a contact surface for measuring a fluid characteristic of the process fluid and the contact surface is self-cleaned by impingement of the process fluid at an oblique angle from the injection nozzle.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described or illustrated with respect to one embodiment may be used in the same way or in a similar way in one or more other embodiments or in combination with or instead of the features of the other embodiments.

### BRIEF DESCRIPTION OF THE DRAWINGS

FIG. 1 is a side cross-sectional view of an exemplary self-contained monitoring system in accordance with embodiments of the present invention.

FIG. 2 is a detailed view of a portion of the system shown in FIG. 1 in accordance with a first exemplary embodiment.

FIG. 3 is a detailed view of the system shown in FIG. 1 in accordance with a second exemplary embodiment.

FIG. 4 is a side cross-sectional view of a self-contained monitoring system having a plurality of housings.

FIG. 5 is a schematic diagram showing operative portions of a self-contained monitoring system in accordance with embodiments of the present invention.

FIG. 6 is a schematic diagram showing operative portions of a self-contained monitoring system in accordance with embodiments of the present invention.

FIG. 7 is a side cross-sectional view of a housing for a self-contained monitoring system in accordance with a second exemplary embodiment of the housing.

FIG. 8 is a side cross-sectional view of a housing for a self-contained monitoring system in accordance with a third exemplary embodiment of the housing.

### DETAILED DESCRIPTION

The principles of the present invention have particular application to biological cultivation systems. An example of such a biological cultivation system is an algae cultivation system. The present invention pertains to a self-contained monitoring system for monitoring a process fluid having a closed loop of fluid flow. The self-contained monitoring system includes at least one housing defining a sensor chamber configured to receive a flow of the process fluid, a sensor positioned within the sensor chamber and having a contact surface configured to measure a fluid characteristic of the process fluid, and an injection nozzle having an inlet fluid passage for withdrawing a process fluid from the fluid source and an outlet fluid passage for discharging the process fluid into the sensor chamber, and a drain passage for returning the entire amount of the extracted process fluid to the fluid source. The injection nozzle is positioned at an oblique angle relative to the contact surface of the sensor such that the contact surface is impinged by the process fluid. Impingement by the process fluid against the contact surface of the sensor allows measurement of the process fluid by the sensor and cleans the contact surface. Embodiments of the present invention will now be described with reference to the drawings, wherein like reference numerals are used to refer to like elements throughout. It will be understood that the figures are not necessarily to scale.

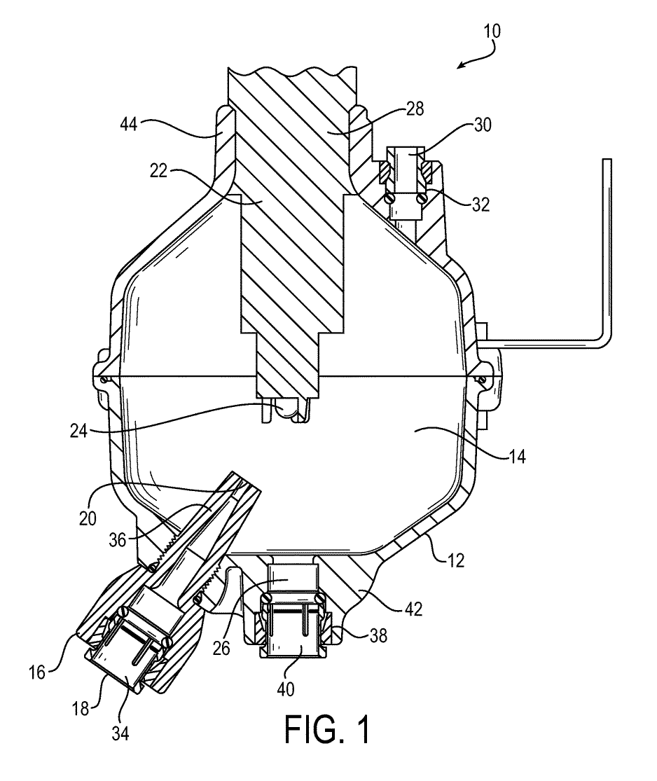

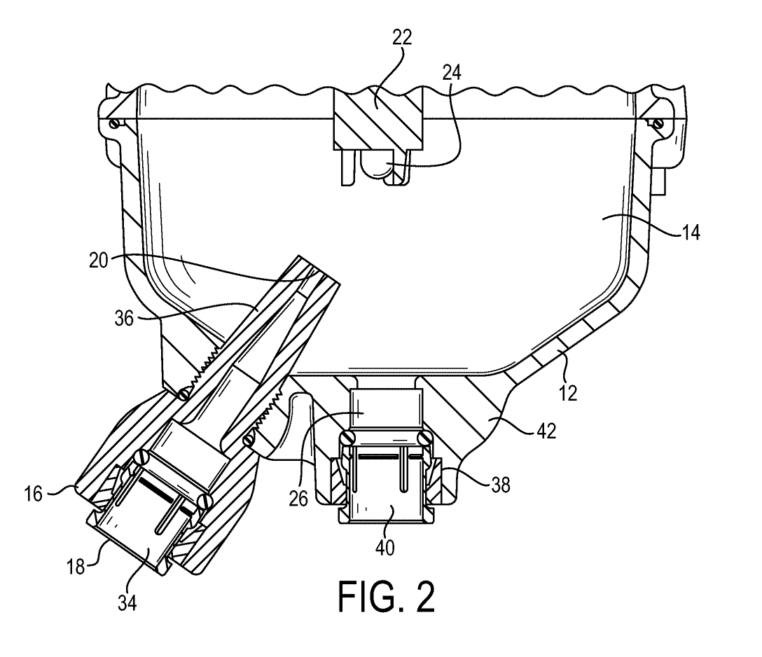

Referring first to FIGS. 1-2, a self-contained monitoring system 10 may include a housing 12 defining a sensor chamber 14 for containing a process fluid withdrawn from a fluid source for measurement. A process fluid includes the contents of the fluid source including a liquid and/or a gas which may also include entrained solid particles, dissolved gases or other contaminants. The self-contained monitoring system 10 may include a single branch or a single stream of process fluid for fluid movement of the process fluid through the system 10. The housing 12 may be formed having dimensions that provide a slower flow rate of the process fluid to provide a constant measurement while minimizing the volume of process fluid to be moved for data collection. The housing 12 may include an air bleed port 30 received in an aperture 32 defined by the housing 12, and in fluid communication with the sensor chamber 14 for controlling fluid pressure in the sensor chamber 14.

The injection nozzle 16 may emit process fluid into the sensor chamber 14 for both measurement of characteristics associated with the process fluid and reducing build-up of bio-film, sediment, debris, and/or other contaminants on a sensor 22 positioned within the sensor chamber 14. The injection nozzle 16 includes an inlet fluid passage 18 and an outlet fluid passage 20. The inlet fluid passage 18 may be positioned externally relative to the housing 12 and in fluid communication with a fluid source for withdrawing a predetermined amount of process fluid from the fluid source. The outlet fluid passage 20 may be positioned for discharging the predetermined amount of process fluid into the sensor chamber 14. The injection nozzle 16 may include at least one jet inlet 34 and at least one jet outlet 36 from which the process fluid is emitted. The jet outlet 36 may have a smaller diameter relative to the sensor chamber 14. The jet inlet 34 may be in fluid communication with the process fluid directly from the fluid source and may be adjustable to control the flow rate of the process fluid emitted into the sensor chamber 14.

Referring now to FIGS. 1-3, the system 10 may include a sensor 22 positioned within the sensor chamber 14 and having a contact surface 24 in fluid communication with the process fluid. The system 10 may include an in-process sensor defined as an analytical instrument which interacts with the process fluid, resulting in a measurement of one or more characteristics of the fluid and its components such as water quality and a growth parameter. The measurable characteristics may include any suitable measuring parameter. Typical examples include pH, conductivity, temperature, dissolved gases and/or concentration of chemical components of the fluid. Example of in-process sensors suitable for use include ion-selective electrodes, electro-chemical gas sensors, galvanic or polarographic electrodes, and potentiometric or inductive probes. The preferred sensor will depend upon application variables such as the equipment being used, operating conditions, the characteristic being measured, and the sensor chamber design. In exemplary embodiments, the body 28 of the sensor 22 may be formed of plastic, metal, glass, or other material treated to resist microbial growth.

The contact surface 24 of the sensor 22 may be positioned relative to the outlet fluid passage 20 of the jet outlet 36 such that a discharged predetermined amount of process fluid impinges on the contact surface 24. The injection nozzle 16 may be positioned at an oblique angle relative to the contact surface 24 such that impingement by the process fluid against the contact surface of the sensor allows measurement of the process fluid by the sensor. An advantage of such configuration is that the contact surface 24 of the sensor 22 is self-cleaned by impingement of the moving fluid. The distance of the jet outlet 36 relative to the sensor 22 may be modified based on the geometry and dimensions of the injection nozzle 16. A preferred distance between the jet outlet 36 and the contact surface 24 of the sensor 22 is approximately between 0.50 inches and 0.80 inches. The angle at which the process fluid may impinge on the contact surface 24 is an oblique angle. The preferred angle is approximately 35° where 0° is parallel to the contact surface 24 and 90° is perpendicular to the sensor surface. The angle may be approximately 20° to 45°. Angles of less than 45° are desirable because the flow trajectory will accommodate greater variety in sensor geometry. Angles of greater than 45° will provide efficiency in removal of debris and sediment from the contact surface. The preferred angle of 35° strikes a balance between cleaning performance and sensor compatibility. Flow through the injection nozzle 16 and sensor chamber 14 may be continuous, such that the predetermined amount of process fluid entering the sensor chamber 14 is approximately equivalent to the amount of process fluid exiting the sensor chamber 14.

The system 10 may include a first exemplary embodiment of the sensor 22 shown in FIG. 2 or a second exemplary embodiment of the sensor 22 shown in FIG.

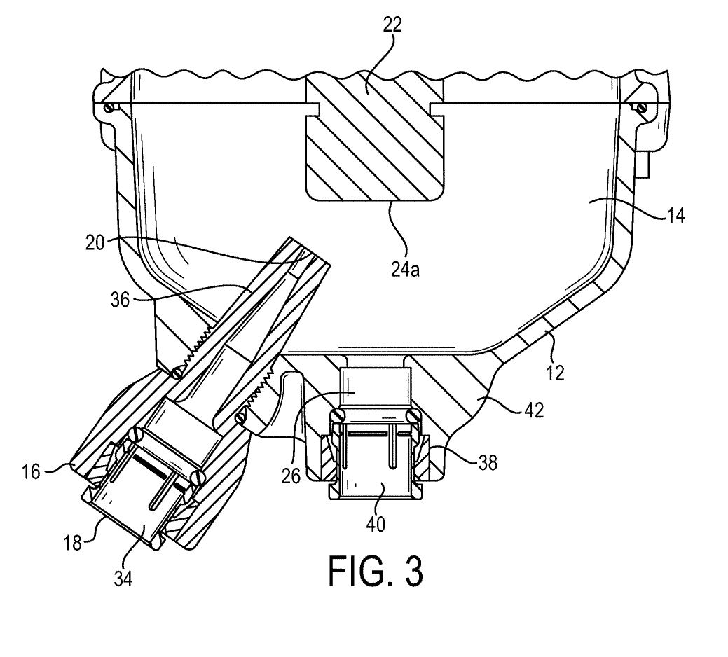

3. FIG. 3 shows the sensor 22 having a contact surface 24a which provides a greater surface area for the process fluid to impinge against. It should be recognized by those skilled in the art that the contact surface 24 and body 28 of the sensor 22 may have a varying geometry as may be suitable for a particular application.

The system 10 may further include a drain passage 26 for returning the predetermined amount of process fluid to the fluid source. The housing 12 may define an aperture 38 receiving a cartridge drain 40 defining the drain passage 26. The drain passage 26 and the sensor 22 may be positioned along a common longitudinal axis of the housing 12. The housing 12 may include a first end 42 and a second end 44 located distally opposite relative to one another. The cartridge drain 40 may be positioned at the first end 42 and the sensor 22 may be positioned at the second end 44 such that the drain passage 26 and the contact surface 24 of the sensor 22 are spaced apart relative to one another. Positioning the drain passage 26 directly below the contact surface 24 allows approximately an entire amount of the process fluid emitted into the sensor chamber 14 to return to the fluid source from which it was withdrawn, preventing accumulation of sediment at the first end 42 of the housing 12. The drain passage 26 may be throttled for controlling an amount of process fluid located in the sensor chamber 14 and maintaining that the sensor 22 is submerged. While this embodiment locates the drain passage coaxially with the sensor, it should be noted that locating the drain passage at the lowest point of the sensor chamber is the principle design criteria for effective removal of sediment from the sensor chamber, due to gravity.

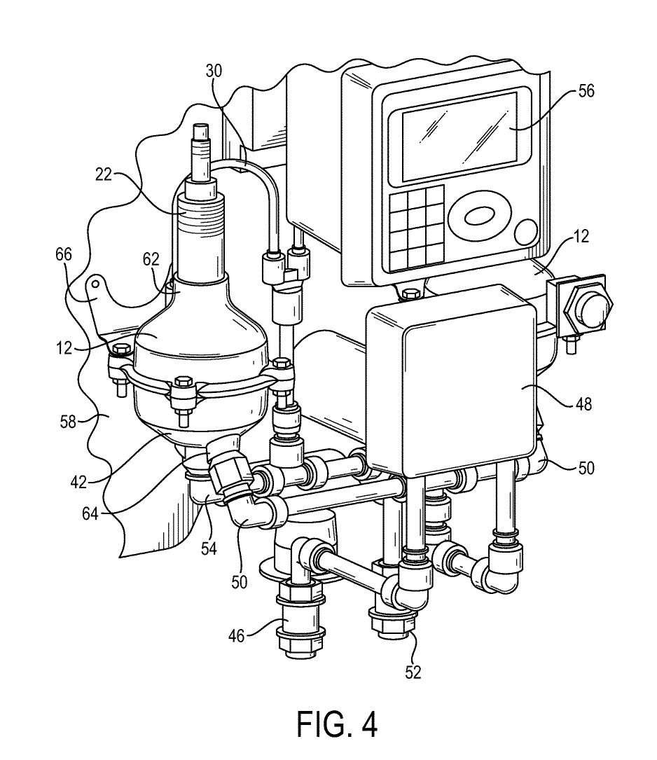

Referring now to FIG. 4, the self-contained system 10 may include a plurality of housings 12 and fluid passages in fluid communication with the fluid source. The self-contained system 10 may include an inlet fluid passage 46 for withdrawing a predetermined amount of process fluid from the fluid source and an outlet fluid passage 52 for returning the process fluid to the fluid source. The system 10 may include a pump 48, which may be a peristaltic, progressive cavity diaphragm or any other suitable pump, in fluid communication between the inlet fluid passage 46 of the system 12 and the inlet fluid passage 18 of the injection nozzle 16 for pressurizing the fluid and generating fluid flow in the system 10 from the fluid source. The pump may be configured to supply a single flow of the process fluid into the system. The system 10 may further include a plurality of first fluid passages 50 in fluid communication between the pump 48 and a corresponding housing 12. A single pump 48 may divide the process fluid from the inlet fluid passage 46 into approximately even amounts of fluid flow entering each of the plurality of first fluid passages 50 and towards the corresponding housing 12. Each of the plurality of housings 12 may include a corresponding injection nozzle 16, drain passage 26, and air bleed port 30 as described herein.

Each of the plurality of housings 12 may include a sensor chamber 14 and sensor 22 having a probe as described herein for measuring one or more characteristics of the process fluid received in each of the plurality of housings 12. The system 10 may further include an output screen 56 for displaying measured data corresponding to the characteristic(s) of the process fluid as measured by the sensor 22. The output screen 56 may be an LCD screen, but may also include wireless communication or a wired output to an auxiliary display and recording device. Each of the drain passages 26 associated with the corresponding housing 12 may be in fluid communication with the outlet fluid passage 52 for returning the process fluid from each of the corresponding sensor chambers to the fluid source. The drain passages 26 may be in fluid communication with the outlet fluid passage 52 through a plurality of second fluid passages 54 corresponding to the plurality of housings 12. In an exemplary embodiment, the system 10 may include one inlet fluid passage 46, one outlet fluid passage 52, and a plurality of first and second fluid passages 50, 54 in fluid communication between the inlet and outlet fluid passages 46, 52 and the plurality of housings 12.

The housing 12 may be formed of a suitable material. An example of a suitable material is plastic. The housing 12 may also be formed by a suitable manufacturing process. An example of a process for forming a plastic housing injection molding. The housing 12 may be formed to have a press-in cartridge portion 62 at the second end 44 of the housing 22. The sensor 22 may include a threaded portion engageable with the press-in cartridge portion 62 of the housing 12 for ease in assembly. The housing 12 may include an o-ring seal 64 sealing the outlet fluid passage 20 of the injection nozzle 16 and the inserted drain cartridge located at the first end 42 of the housing 12. The housing 12 may additionally be mounted within a self-contained unit 58 via a mount 66. It should be recognized that any suitable mount may be implemented.

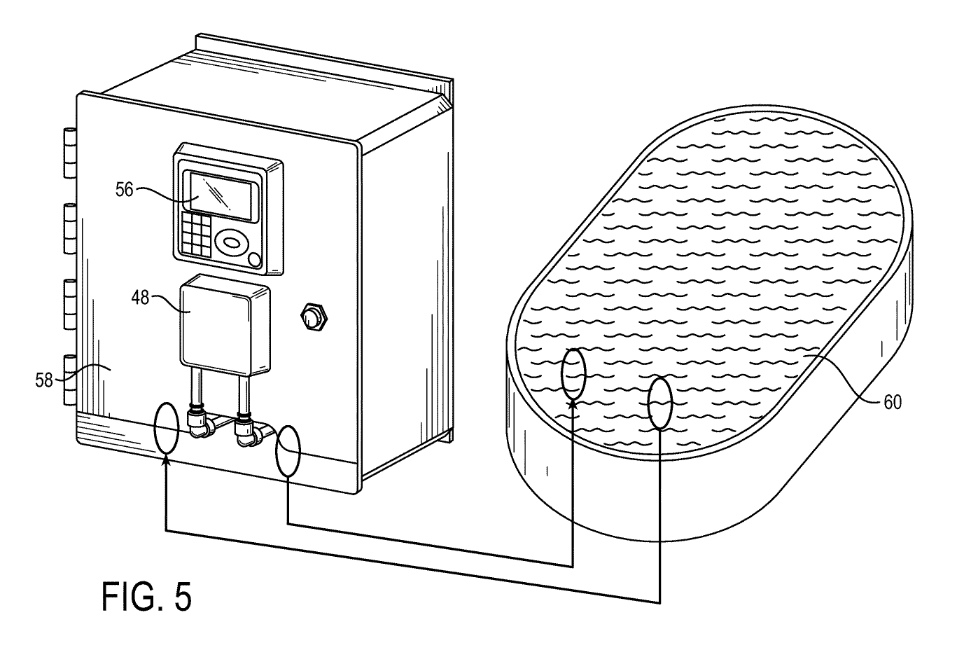

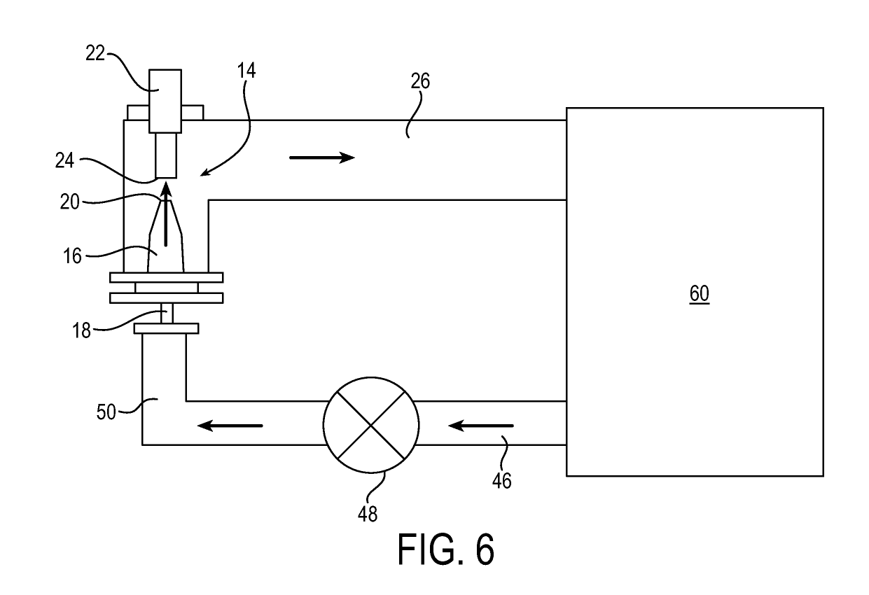

Referring now to FIGS. 5-6, the self-contained system 10 for monitoring a fluid source is shown in fluid communication with a fluid source 60. The fluid source may be a fluid cultivation system or an algae cultivation system. The algae cultivation system may include an open pond, such that the fluid source is a natural water source. The fluid source may be a wastewater flocculation and clarification tank or an equalization tank for dewatering filtrate. The system 10 may be self-contained in a unit 58 located remotely with respect to the fluid source 60, or open pond. It should be recognized that the self-contained monitoring system may be suitable in other systems using a sensor in contact with a fluid to prevent buildup of undesired particles on the sensor surface. Suitable systems may include water treatment for waste management companies, such that the fluid source is a waste water system. The fluid source may include any suitable process fluid.

FIG. 6 is schematic diagram showing the closed-loop fluid flow of the self-contained system 10. In operation, the pump 48 may withdraw process fluid from the fluid source 60 through inlet fluid passage 46. The pump 48 may pressurize the process fluid through a first fluid passage 50 towards the inlet fluid passage 18 of the injection nozzle 16. The injection nozzle 16 may emit the process fluid through an outlet fluid passage 20 of the injection nozzle 16 and into a sensor chamber 14 defined by a housing 12. The injection nozzle 16 may be positioned such that the emitted process fluid impinges a contact surface 24 of a sensor 22 within the sensor chamber 14. Approximately an entire amount of the process fluid withdrawn from the fluid source 60 may then be returned to the fluid source 60 via a drain passage 26 of the housing 12. The self-contained system 10 provides in-process cleaning of the contact surface 24 of the sensor 22 and a direct fluid path in and out of the system 10 for monitoring contaminants.

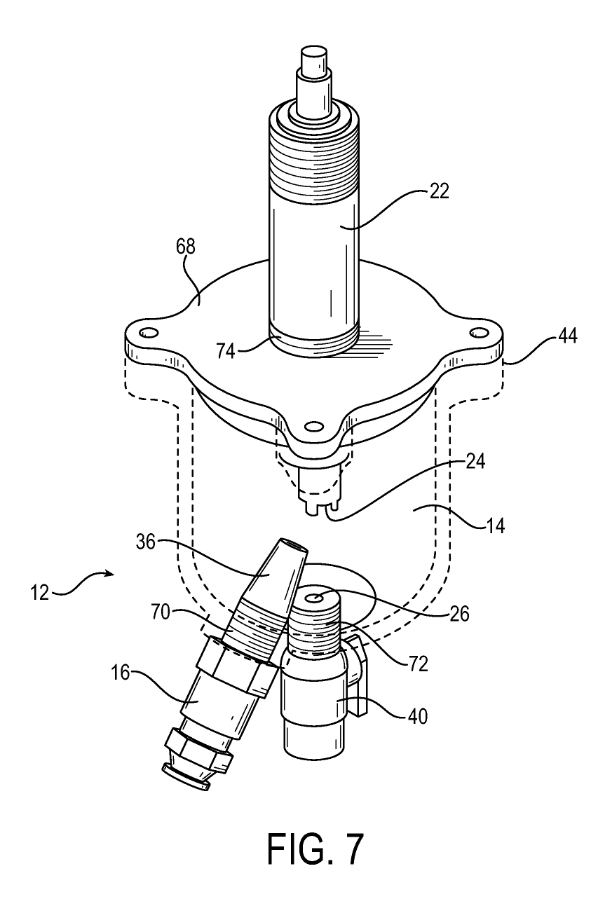

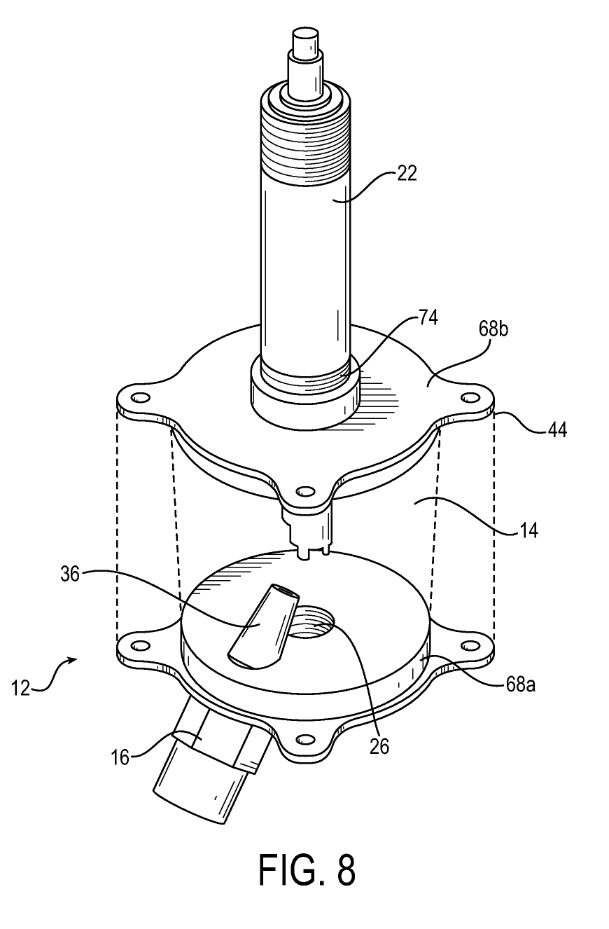

FIGS. 7-8 illustrate exemplary embodiments of the housing 12. The housing 12 may be formed by extrusion or injection molding. The sensor chamber 14 may be formed of a acetal material and the injection nozzle 16 may include a threaded portion 70 engageable with the housing 12 such that the jet outlet 36 extends through the material for emitting the process fluid into the sensor chamber 14. FIG. 7 shows the housing 12 including a cover plate 68 located at the second end 44 of the housing 12. A threaded portion 74 of the sensor 22 may extend through the cover plate 68 and into the sensor chamber 14. The cover plate 68 may be bolted to the housing 12. The drain 40 may include a threaded portion 72 engageable with the housing 12 for fluidly communicating the drain passage 26 from the sensor chamber 14 to the fluid source. FIG. 8 shows the housing 12 including a first cover plate 68a located at the first end 42 of the housing 12 and a second cover plate 68b located at the second end 44 of the housing 12. In this embodiment the injection nozzle is integrated into the molded cover plate 68a. The first and second cover plates 68a, 68b may enclose the sensor chamber 14.

A method of self-cleaning a sensor in a monitoring assembly for a process fluid may include receiving a predetermined amount of process fluid into an inlet fluid passage of an injection nozzle, injecting the predetermined amount of process fluid from an outlet fluid passage of the injection nozzle into a sensor chamber housing the sensor, and removing the predetermined amount of process fluid from the sensor chamber via a drain passage. The sensor may include a contact surface for measuring a fluid characteristic of the process fluid and the contact surface may be self-cleaned by impingement of the process fluid at an oblique angle from the injection nozzle. The method may further include positioning the injection nozzle at an angle ranging between 20° and 45°, where 0° is parallel to the contact surface and 90° is perpendicular to the contact surface. The preferred angle may be 35°. The method may further include positioning the drain passage and the sensor along a common axis of the sensor chamber, where the drain passage is located directly below the sensor and spaced apart from the contact surface of the sensor. The method may further include displaying a measured value of the fluid characteristic of the process fluid on an LCD screen and adjusting the injection nozzle to control a flow rate of the predetermined amount of process fluid into the sensor chamber. The process fluid in the self-cleaning method may be withdrawn from an algae cultivation pond.

A self-contained monitoring assembly for monitoring a process fluid comprises at least one housing defining a sensor chamber configured to receive a flow of the process fluid, a sensor positioned within the sensor chamber and having a contact surface configured to measure a fluid characteristic of the process fluid, an injection nozzle having an inlet fluid passage receiving a predetermined amount of process fluid and an outlet fluid passage discharging the predetermined amount of process fluid into the sensor chamber, the injection nozzle positioned at an oblique angle relative to the contact surface such that the contact surface is impinged by the process fluid, and a drain passage for removing the predetermined amount of process fluid from the sensor chamber. Impingement by the process fluid against the contact surface of the sensor allows measurement of the process fluid by the sensor and cleans the contact surface by simultaneously reducing and removing debris build up.

The self-contained monitoring assembly may include the inlet fluid passage positioned externally to the at least one housing. The injection nozzle may be positioned at an angle between approximately 20° and 45°, wherein 0° is parallel to the contact surface and 90° is perpendicular to the contact surface. The injection nozzle may be positioned at an angle of approximately 35°. The injection nozzle may be adjustable to control a flow rate of the predetermined amount of process fluid into the sensor chamber.

The drain passage may be positioned at a lowest point in the sensor chamber or at an end of the at least one housing spaced apart from the contact surface of the sensor. The drain passage and the sensor may be positioned along a common axis of the at least one housing. The drain passage may be throttled for controlling an amount of process fluid located in the sensor chamber.

The at least one housing may comprise a plurality of housings, where each of the plurality of housings have a corresponding injection nozzle, sensor, and drain passage.

The sensor may be configured to measure a fluid characteristic of the process fluid comprising at least one of pH, conductivity, temperature, dissolved gases and concentration of chemical components of the fluid. The sensor may include a body formed of a material resistant to microbial growth.

The sensor chamber may include an air bleed port for controlling fluid level in the sensor chamber.

A fluid monitoring system may include the self-contained monitoring assembly. The monitoring system may include a fluid source and the predetermined amount of process fluid is withdrawn from the fluid source. The monitoring assembly may be located remotely from the fluid source. The fluid source may be one of an algae cultivation pond, a wastewater flocculation and clarification tank, and an equalization tank for dewatering filtrate. The system may include a pump in fluid communication between the fluid source and the inlet fluid passage of the injection nozzle for pumping the predetermined amount of the process fluid from the fluid source to the nozzle.

The monitoring system may include an output screen for displaying a measured value of the fluid characteristic of the process fluid, wherein the output screen includes wireless communication or a wired output to an auxiliary display and recording device.

A method of self-cleaning a sensor in a monitoring assembly for a process fluid comprising the steps of receiving a predetermined amount of process fluid into an inlet fluid passage of an injection nozzle, injecting the predetermined amount of process fluid from an outlet fluid passage of the injection nozzle into a sensor chamber housing the sensor, the sensor having a contact surface for measuring a fluid characteristic of the process fluid, wherein the contact surface is cleaned by impingement of the process fluid at an oblique angle from the injection nozzle, and removing the predetermined amount of process fluid from the sensor chamber via a drain passage.

The self-cleaning method may further comprise positioning the injection nozzle at an angle between approximately 20° and 45°, wherein 0° is parallel to the contact surface and 90° is perpendicular to the contact surface. The method may further comprise positioning the injection nozzle at an angle of approximately 35°. The method may further comprise adjusting the injection nozzle to control a flow rate of the predetermined amount of process fluid into the sensor chamber.

The method may further comprise positioning the drain passage at a lowest point in the sensor chamber, where the drain passage is spaced apart from the contact surface of the sensor. The method may further comprise positioning the drain passage and the sensor along a common axis of the sensor chamber.

The method may further comprise displaying a measured value of the fluid characteristic of the process fluid on an output screen using wireless communication or a wired output to an auxiliary display and recording device.

The method may further comprise withdrawing the fluid from one of an algae cultivation pond, a wastewater flocculation and clarification tank, and an equalization tank for dewatering filtrate.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A self-contained monitoring assembly for monitoring a process fluid comprising:
at least one housing defining a sensor chamber configured to receive a flow of the process fluid;
a sensor positioned within the sensor chamber and having a contact surface configured to measure a fluid characteristic of the process fluid;
an injection nozzle having an inlet fluid passage receiving a predetermined amount of process fluid and an outlet fluid passage discharging the predetermined amount of process fluid into the sensor chamber, the injection nozzle positioned at an oblique angle relative to the contact surface such that the contact surface is impinged by the process fluid; and
a drain passage for removing the predetermined amount of process fluid from the sensor chamber;
wherein impingement by the process fluid against the contact surface of the sensor allows measurement of the process fluid by the sensor and cleans the contact surface by simultaneously reducing and removing debris build up.

2. The self-contained monitoring assembly of claim 1, wherein the inlet fluid passage is positioned externally to the at least one housing.

3. The self-contained monitoring assembly of claim 1, wherein the injection nozzle is positioned at an angle between approximately 20° and 45°, wherein 0° is parallel to the contact surface and 90° is perpendicular to the contact surface

4. (canceled)

5. The self-contained monitoring assembly of claim 1, wherein the drain passage is positioned at a lowest point in the sensor chamber, the drain passage positioned at an end of the at least one housing spaced apart from the contact surface of the sensor.

6. The self-contained monitoring assembly of claim 1, wherein the drain passage and the sensor are positioned along a common axis of the at least one housing.

7. (canceled)

8. The self-contained monitoring assembly of claim 1, wherein the at least one housing comprises a plurality of housings, each of the plurality of housings having a corresponding injection nozzle, sensor, and drain passage according to any of claims 1-7.

9. The self-contained monitoring assembly of claim 1, wherein the drain passage is throttled for controlling an amount of process fluid located in the sensor chamber.

10-11. (canceled)

12. The self-contained monitoring assembly of claim 1, wherein the sensor chamber has an air bleed port for controlling fluid level in the sensor chamber.

13. A fluid monitoring system including the self-contained monitoring assembly of claim 1, and further comprising:
a fluid source, wherein the predetermined amount of process fluid is withdrawn from the fluid source.

14. The fluid monitoring system of claim 13, wherein the self-contained monitoring assembly is located remotely from the fluid source.

15. The fluid monitoring system of claim 13 further comprising:
a pump in fluid communication between the fluid source and the inlet fluid passage of the injection nozzle for pumping the predetermined amount of the process fluid from the fluid source to the nozzle.

16. The fluid monitoring system of claim 13, wherein the fluid source is one of a fluid cultivation system, a waste water system, a natural water source, and a process fluid.

17. The fluid monitoring system of claim 1 further comprising:
an output screen for displaying a measured value of the fluid characteristic of the process fluid, wherein the output screen includes wireless communication or a wired output to an auxiliary display and recording device.

18. (canceled)

19. A method of self-cleaning a sensor in a monitoring assembly for a process fluid comprising the steps of:
receiving a predetermined amount of process fluid into an inlet fluid passage of an injection nozzle;
injecting the predetermined amount of process fluid from an outlet fluid passage of the injection nozzle into a sensor chamber housing the sensor, the sensor having a contact surface for measuring a fluid characteristic of the process fluid, wherein the contact surface is cleaned by impingement of the process fluid at an oblique angle from the injection nozzle; and
removing the predetermined amount of process fluid from the sensor chamber via a drain passage.

20. The self-cleaning method of claim 19 further comprising:
positioning the injection nozzle at an angle between approximately 20° and 45°, wherein 0° is parallel to the contact surface and 90° is perpendicular to the contact surface.

21. (canceled)

22. The self-cleaning method of claim 19 further comprising:
positioning the drain passage at a lowest point in the sensor chamber, the drain passage spaced apart from the contact surface of the sensor.

23. The self-cleaning method of claim 22 further comprising:
positioning the drain passage and the sensor along a common axis of the sensor chamber.

24. The self-cleaning method of claim 19 further comprising:
displaying a measured value of the fluid characteristic of the process fluid on an output screen using wireless communication or a wired output to an auxiliary display and recording device.

25. (canceled)

26. The self-cleaning method of claim 19 further comprising:
adjusting the injection nozzle to control a flow rate of the predetermined amount of process fluid into the sensor chamber.

27. The self-cleaning method of claim 19 further comprising:
withdrawing the fluid from one of an algae cultivation pond, a wastewater flocculation and clarification tank, and an equalization tank for dewatering filtrate.
